(19) United States
(12) Patent Application Publication
(10) Pub. No.: US 2007/0206188 A1
(43) Pub. Date: Sep. 6, 2007

(54) Cyclops a 4-dimensional planetary scanning laser imaging telescope

(76) Inventor: Todd J. Tocco, Schenectady, NY (US)

Correspondence Address: Todd J. Tocco, 2014 Fiero Avenue, Schenectady, NY, 12303-4109, US

(21) Appl. No.: 11/364,723

(22) Filed: Mar. 1, 2006

(51) Int. Cl. G01N 21/00

(52) U.S. Cl. 356/337; 398/118

(57) ABSTRACT

Similar to a laser copier and fiber optics this system scans planetary objects in deep space this 940 mm invisible laser system is programmable multitasking and moves at light speed to its destination the only down time is the travel time between the two points in space it then scans the planets surface using present day technologies remembering that this system is programmable. A light Beam Receiver/Transmitter combined as a possible means of listening to and communicating with these planets in the search for extra terrestrial life forms. It sends the digital information back to earth through what I call a wormhole in space and time, which is the laser beams own path. The information will be sent back to earth will be instantaneous to give us a clear 3-dimensional image of the planet's surface with water soil mineral readings.

I claim; This Invention uses invisible laser technology to scan and to view any and all objects that it comes in contact with as it touches down on the planets surface. This new type of telescope design in which I claim; And is the first of its kind anywhere and I claim; The only one that can see through the day light sky I claim; This system can even see through the heaviest of cloud cover, that is because of the amount of heat that can be produced by the laser as needed to evaporate those pesky clouds once and for all. The collection of tiny water an ice crystals was a nightmare for the astronomer but this unit is a laser and if a laser can cut through a ½ inch steel plate, then why not evaporate the problem at hand. I claim; clouds aren't a problem any longer for this laser system. I claim; Another problem was light pollution, now that's no longer an issue, being made up totally of light. I claim; This 940 mm laser system uses present-day laser technology to aid in the discovery of new planetary and possible life forms research. I claim; This system can scan and received data along its own laser light beam path similar to a fiber optic cable and can scan like a bar code scanner or a laser copier and I claim; This telescope system also has the ability to move at incredible rates of speed jumping all around in space faster then a blink of an eye. Try to imagine what a one-half inch movement from a laser pointer would be on a wall in your class room, or office. Now try and image that same distance in deep space; you Just made the jump from “Onions Mintaka to Orions Rigel.” Now that's fast once the laser beam leaves earth and travels at light speed to its next destination; I claim; It's as simple as pointing a digital camera at your next subject, in fact, the whole cosmos and even the entire universe can be seen this way. I claim; Why not probe a black hole with this new type of laser imaging telescope. Just remember leaving this laser telescope on all of the time only means it will just reach out into the cosmos and the universe that much further, going deeper and farther into the past and to the beginning of time, I claim; it then returns the digital information by way of a fourth dimension in space, or a laser wormhole from the lasers beams own path this is similar to a fiber optic cable; and the way that it receives and sends its information. I claim; this wormhole is a gateway back to the present. Which now makes the fourth dimension possible; I claim; this dimension is a gateway back in time or brings the past to the present. Some astronomers and scientist believe that the universe is moving away or expending outward and they also believe that you are looking at the past or the beginning of time. I claim: That when this laser's beam reaches its final destination on a planet surface that the information that returns will be instance-tonus time will fold in on itself some scientist here on earth are saying that the information that is viewed by a telescope as sent back to earth is from the past thus I claim: The information will be sent back through a wormhole effect coming from the laser beams telescopes own path this light allows the time that it takes to reach the planet on returning to fold in on itself like a fiber optic cable can send and receives its data this digital information as it passes through the wormhole that returns will be instance-tonus for this state of the art new telescope design in which it uses six UV/laser modules or one (Vulcan/Photon laser which-ever are more effective or cost effective.)

As the laser light beam from this unit leaves the telescope which then travels at light speed to first penetrate through our cloud cover if any here on earth and then to its destination. I claim; The only down time is the commute between the two points in the cosmos, at its arrival, it penetrates that planet's cloud cover if any and touches down on the planets surface; I claim; Because this system is programmable any type of light emitting laser system can be programmed to be excepted into the laser. For example, it then scans using one of six programmable ways listed below or all six at one time they are as follows:

Thermal Wave Imaging; Digital Laser Imaging; Digital 3D Color Laser Scanner;

Infrared Camera Technologies; Laser Range Finder;

A light Beam Receiver/Transmitter/combined: Is also included as a possible means of listening to and communicating with these planets in the search for extra terrestrial life forms.

A light-year is defined as the distance light travels in one year the velocity of light is relatively constant at 186.288 miles per second (or approximately 670 million miles per hour) That's to Mars in about 25 minutes, in other words, what it would take NASA months to do, this system can do in minutes. It takes light a little over eight minutes to travel the 93 million miles from the sun to the earth. Now try to imagine how far that same point of light will travel in a year, that distance is a light-year. 1 light-year=5.88 billion miles (5.881,000,000,000 miles). Our whole galaxy (the milky way) is only 100.000 light-years in diameter, keeping that in mind a little movement from the earths surface is a very big movement in deep space having the ability to move at incredible rates of speed. Is one of the reasons that makes this system so unique.

I claim:

1. The 3-dimensional image that is then sent back to earth along the energy beam of invisible laser light, through the wormhole giving us, here on earth with the aid of the main frame computer, system a 3-dimensional image by way of the plasma screen monitor here at home. I claim; Of the planetary object in a girding form of the longitude and latitude showing all the peeks and valleys of the laid of the land the computer generation image of what the new worlds would look like, yet unseen by the naked eye is sent back to earth along that energy beam. I claim; This wormhole in space brings the past to the present with all the material and soil readings plant life readings water and environmental atmospheric conditions etc. I claim; We can explore whole new worlds without ever leaving home, less cost and expense. Let's think of all the masteries of the cosmos and the universe not yet thought of. I claim; I would like to see each laser system, to be multi-programmable multi-functional or multi-tasking of one or more of the laser module, so another can take its place or a replacement can be found because of the possibility of a laser module burn out. So lets reach out and touch someone.
